(19) United States
(12) Patent Application Publication
(10) Pub. No.: US 2026/0180464 A1
(43) Pub. Date: Jun. 25, 2026

(54) ELECTRICAL POWER SUPPLY SYSTEM

(71) Applicant: HONDA MOTOR CO., LTD., Tokyo (JP)

(72) Inventor: Kenji Noguchi, Wako-shi (JP)

(21) Appl. No.: 19/428,759

(22) Filed: Dec. 22, 2025

(30) Foreign Application Priority Data
Dec. 25, 2024 (JP) 2024-228404

(51) Int. Cl. H02M 7/217; H02M 1/32

(52) U.S. Cl. CPC H02M 7/2173; H02M 1/327

(57) ABSTRACT

A converter includes a plurality of switching element units corresponding to respective phases of a multiphase AC voltage, each of the switching element units including a switching element (upper arm-side switching element) on an upper arm side and a switching element (lower arm-side switching element) on a lower arm side, the upper arm-side switching element and the lower arm-side switching element being connected in series to each other. In a case that a determination unit determines that a short-circuit failure has occurred in any of the plurality of switching elements provided in the converter, a control unit can perform first control of placing, in an ON-state, all the switching elements provided in the converter.

### CROSS-REFERENCE TO RELATED APPLICATIONS

This application is based upon and claims the benefit of priority from Japanese Patent Application No. 2024-228404 filed on December 25, 2024, the contents of which are incorporated herein by reference.

### BACKGROUND OF THE INVENTION

### FIELD OF THE INVENTION

The present disclosure relates to an electrical power supply system.

### DESCRIPTION OF THE RELATED ART

JP 2016-123141 A discloses a technique for coping with a short-circuit failure occurring in an inverter in an electric motor system including the inverter and a three-phase AC motor.

### SUMMARY OF THE INVENTION

An electrical power supply system has been used in which an electrical power conversion circuit (for example, a converter) converts a multiphase AC electrical power output from a generator into a DC electrical power and outputs the DC electrical power. In such an electrical power supply system, it is desired to perform suitable control in the case that a short-circuit failure occurs in the electrical power conversion circuit.

The present disclosure has the object of solving the aforementioned problem.

An aspect of the present disclosure is characterized by an electrical power supply system comprising: a converter including a plurality of switching elements and configured to convert a multiphase alternating current voltage output from a generator into a direct current voltage; a control unit configured to control the converter; and a determination unit configured to determine whether or not a short-circuit failure has occurred in any of the plurality of switching elements provided in the converter, wherein the converter includes a plurality of switching element units corresponding to respective phases of the multiphase alternating current voltage, each of the switching element units including an upper arm-side switching element that is one of the switching elements on an upper arm side, and a lower arm-side switching element that is one of the switching elements on a lower arm side, the upper arm-side switching element and the lower arm-side switching element being connected in series to each other, and in a case that the determination unit determines that the short-circuit failure has occurred in any of the plurality of switching elements provided in the converter, the control unit can perform first control of placing, in an ON-state, all of the switching elements provided in the converter.

According to the present disclosure, it is possible to perform suitable control in the case that a short-circuit failure occurs in an electrical power conversion circuit.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of an electrical power supply system according to one embodiment;

FIG. 2 is a schematic diagram of a first electrical power generating device according to the one embodiment;

FIG. 3 is a schematic diagram illustrating an example of a backflow prevention device according to the one embodiment;

FIG. 4 is a schematic diagram illustrating another example of the backflow prevention device according to the one embodiment;

FIG. 5 is a control block diagram of a control device according to the one embodiment;

FIG. 6 is a diagram showing operations of the electrical power supply system at a normal time according to the one embodiment;

FIG. 7 is a flowchart of a process for coping with a short-circuit failure;

FIG. 8A is a diagram showing respective phase electrical currents supplied from a first generator to a first converter;

FIG. 8B is a diagram showing electrical currents flowing through the upper arm side of the first converter according to the one embodiment;

FIG. 8C is a diagram showing electrical currents flowing through the lower arm side of the first converter according to the one embodiment;

FIG. 8D is a diagram showing switch signals according to the one embodiment;

FIG. 9 is a diagram showing operations of the first converter according to the one embodiment;

FIG. 10A is a diagram showing respective phase electrical currents supplied from the first generator to the first converter according to a comparative example;

FIG. 10B is a diagram showing electrical currents flowing through the upper arm side of the first converter according to the comparative example;

FIG. 10C is a diagram showing electrical currents flowing through the lower arm side of the first converter according to the comparative example;

FIG. 10D is a diagram showing switch signals according to the comparative example;

FIG. 11 is a diagram showing operations of the first converter according to the comparative example;

FIG. 12 is a flowchart of a process for suppressing a temperature difference among a plurality of switching elements;

FIG. 13 is a flowchart of a process for shifting from second control to first control; and

FIG. 14 is a schematic diagram of a moving object.

### DETAILED DESCRIPTION OF THE INVENTION

A converter that converts a multiphase AC electrical power (voltage, electrical current) into a DC electrical power (voltage, electrical current) includes a switching element unit individually for each phase of the multiphase AC electrical power. Each switching element unit includes a switching element on the upper arm side and a switching element on the lower arm side that are connected in series to each other.

In such a converter, when a short-circuit failure (on-sticking failure) occurs in any of the switching elements, problems occur such as heat generation and demagnetization of a generator that supplies the multiphase AC electrical power to the converter. In order to avoid such a problem, it is conceivable to turn on all the switching elements of the arms on the same side as the arm that includes the switching element in which the short-circuit failure has occurred. For example, in the case that a short-circuit failure occurs in any of the switching elements on the upper arm side, an increased amount of heat generated by the generator and demagnetization of the generator can be reduced by controlling all the switching elements on the upper arm side to be in an ON-state at all times.

However, if the switching elements are placed in the ON-state at all times, another problem occurs in that the switching elements are brought into a high temperature state. The present disclosure provides an electrical power supply system capable of suppressing a temperature rise of switching elements provided in a converter.

### Configuration of Electrical Power Supply System 10

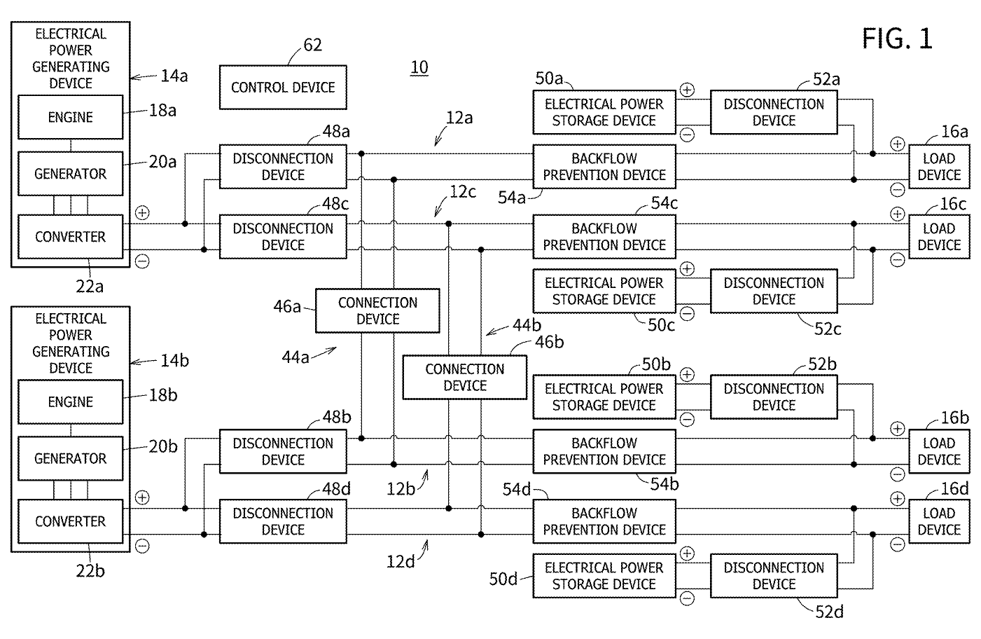

FIG. 1 is a schematic diagram of an electrical power supply system 10 according to one embodiment. As shown in FIG. 1, the electrical power supply system 10 includes a first electrical power supply circuit 12a, a second electrical power supply circuit 12b, a third electrical power supply circuit 12c, and a fourth electrical power supply circuit 12d. The first electrical power supply circuit 12a supplies, to a first load device 16a, a DC electrical power that is output from a first electrical power generating device 14a. The second electrical power supply circuit 12b supplies, to a second load device 16b, a DC electrical power that is output from a second electrical power generating device 14b. The third electrical power supply circuit 12c supplies, to a third load device 16c, the DC electrical power output from the first electrical power generating device 14a. The fourth electrical power supply circuit 12d supplies, to a fourth load device 16d, the DC electrical power output from the second electrical power generating device 14b.

The electrical power supply system 10 is provided with the first electrical power generating device 14a and the second electrical power generating device 14b. The first electrical power generating device 14a includes a first engine 18a, a first generator 20a, and a first converter 22a. The second electrical power generating device 14b includes a second engine 18b, a second generator 20b, and a second converter 22b. The first engine 18a and the second engine 18b, for example, are gas turbine engines. Moreover, the first engine 18a and the second engine 18b may be other engines such as reciprocating engines. The first generator 20a is driven by the first engine 18a and thereby generates a three-phase AC electrical power. The first converter 22a converts the three-phase AC electrical power that is output from the first generator 20a into a DC electrical power. The second generator 20b is driven by the second engine 18b and thereby generates a three-phase AC electrical power. The second converter 22b converts the three-phase AC electrical power that is output from the second generator 20b into a DC electrical power.

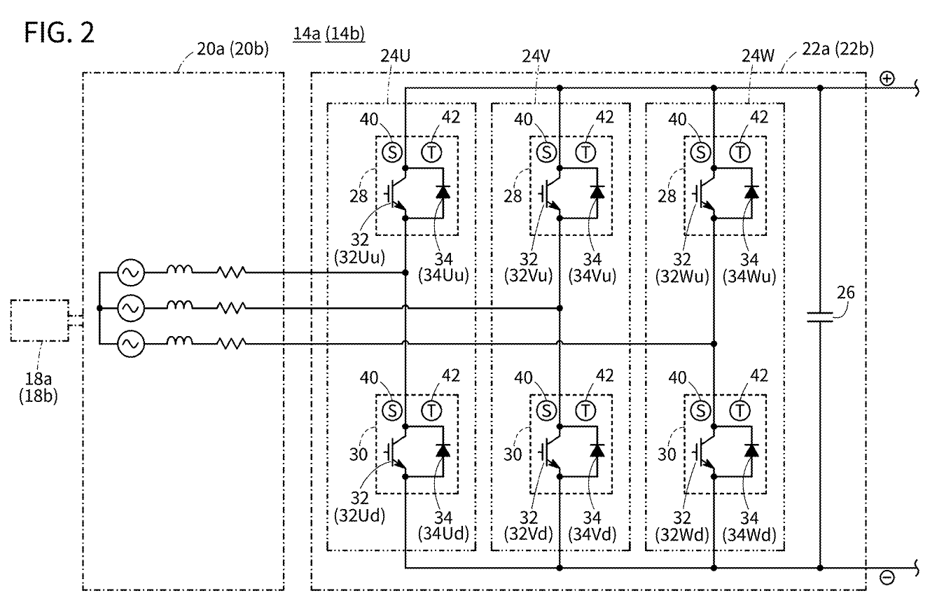

FIG. 2 is a schematic diagram of the first electrical power generating device 14a according to the one embodiment. The second electrical power generating device 14b has the same configuration as the first electrical power generating device 14a. As shown in FIG. 2, the first converter 22a provided in the first electrical power generating device 14a includes: switching element units 24U, 24V, and 24W corresponding to respective phases of the three-phase voltage output from the first generator 20a; and a smoothing capacitor 26. The switching element units 24V and 24W have the same configuration as the switching element unit 24U.

The switching element unit 24U includes an upper arm 28 and a lower arm 30. The upper arm 28 includes a switching element (an upper arm-side switching element) 32 (32Uu, 32Vu, 32Wu), and a diode 34 (34Uu, 34Vu, 34Wu). The lower arm 30 includes a switching element (a lower arm-side switching element) 32 (32Ud, 32Vd, 32Wd) and a diode 34 (34Ud, 34Vd, 34Wd). For example, in the switching element unit 24U, the switching element 32Uu and the switching element 32Ud are connected in series to each other. That is, a first end portion of the switching element 32Uu is connected to a positive wire of the first converter 22a. A second end portion of the switching element 32Uu is connected to a first end portion of the switching element 32Ud. A second end portion of the switching element 32Ud is connected to a negative wire of the first converter 22a. The second end portion of the switching element 32Uu and the first end portion of the switching element 32Ud are connected to a terminal of the first phase (for example, the U phase) of the first generator 20a. The anode of the diode 34Uu is connected to the second end portion of the switching element 32Uu. The cathode of the diode 34Uu is connected to the first end portion of the switching element 32Uu. The anode of the diode 34Ud is connected to the second end portion of the switching element 32Ud. The cathode of the diode 34Ud is connected to the first end portion of the switching element 32Ud.

Moreover, in the switching element unit 24V, a second end portion of the switching element 32Vu and a first end portion of the switching element 32Vd are connected to a terminal of the second phase (for example, the V phase) of the first generator 20a. In the switching element unit 24W, a second end portion of the switching element 32Wu and a first end portion of the switching element 32Wd are connected to a terminal of the third phase (for example, the W phase) of the first generator 20a.

Each switching element 32 is a semiconductor switch (a power device) such as a metal oxide semiconductor field effect transistor (MOSFET) or an insulated gate bipolar transistor (IGBT).

In the first converter 22a, by controlling the timing of turning on and off the switching elements 32, the three-phase AC electrical power output from the first generator 20a is rectified and converted into a DC electrical power. The voltage fluctuation of the rectified DC electrical power is suppressed by the smoothing capacitor 26, and a DC electrical power with a stable voltage is output from the first converter 22a. In the case that the first generator 20a is started, the smoothing capacitor 26 needs to be charged in advance.

Each upper arm 28 is provided with a short-circuit sensor (a voltage sensor or an electrical current sensor) 40 for detecting a short-circuit failure of the switching element 32. Similarly, each lower arm 30 is provided with a short-circuit sensor 40 for detecting a short-circuit failure of the switching element 32.

Each upper arm 28 is provided with a temperature sensor 42 for detecting the temperature of the switching element 32. Similarly, each lower arm 30 is provided with a temperature sensor 42 for detecting the temperature of the switching element 32.

The first converter 22a and the second converter 22b may each include other sensors, and elements such as a fuse, a relay, a breaker, a diode, a transistor, a resistor, a coil, and a capacitor.

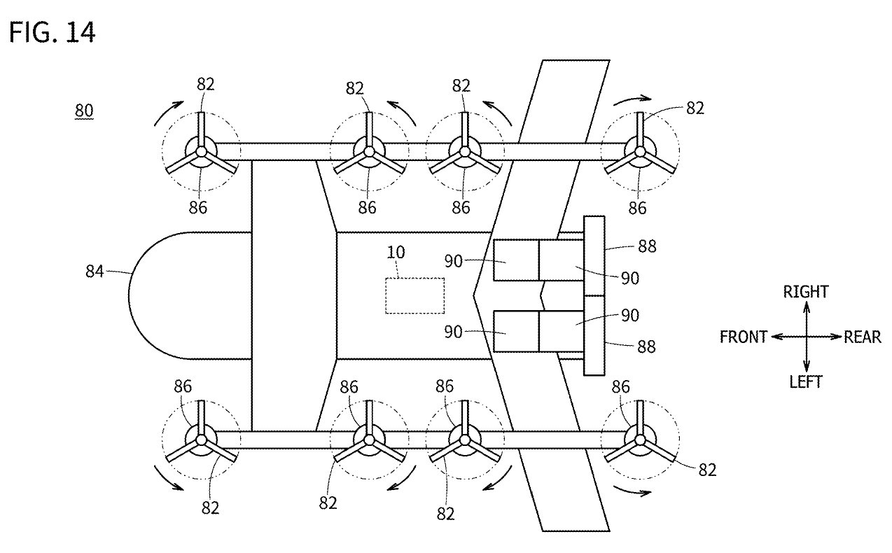

As shown in FIG. 1, the electrical power supply system 10 includes the first load device 16a, the second load device 16b, the third load device 16c, and the fourth load device 16d. The first load device 16a, the second load device 16b, the third load device 16c, and the fourth load device 16d each include, for example, an inverter and an electric motor (for example, see electric motors 86 and 90 in FIG. 14). The inverter converts an input DC electrical power into a three-phase AC electrical power, and the electric motor is driven by the three-phase AC electrical power. The first load device 16a, the second load device 16b, the third load device 16c, and the fourth load device 16d may each include a non-illustrated DC/DC converter and a low-voltage drive device. The DC/DC converter causes the voltage of the input DC electrical power to be reduced, and the low-voltage drive device is driven by the DC electrical power.

The first load device 16a, the second load device 16b, the third load device 16c, and the fourth load device 16d may each include various sensors such as a voltage sensor and an electrical current sensor, and elements such as a fuse, a relay, a breaker, a diode, a transistor, a resistor, a coil, and a capacitor. A plurality of the first load devices 16a may be connected in parallel to each other to the first electrical power supply circuit 12a. A plurality of the second load devices 16b may be connected in parallel to each other to the second electrical power supply circuit 12b. A plurality of the third load devices 16c may be connected in parallel to each other to the third electrical power supply circuit 12c. A plurality of the fourth load devices 16d may be connected in parallel to each other to the fourth electrical power supply circuit 12d.

The electrical power supply system 10 is provided with a connection circuit 44a and a connection circuit 44b. The connection circuit 44a is provided with a connection device 46a. The connection circuit 44b is provided with a connection device 46b.

The connection device 46a is capable of connecting the first electrical power supply circuit 12a and the second electrical power supply circuit 12b. The connection device 46a is switched, by a non-illustrated contactor, between a state in which the first electrical power supply circuit 12a and the second electrical power supply circuit 12b are connected, and a state in which the first electrical power supply circuit 12a and the second electrical power supply circuit 12b are disconnected.

Similarly, the connection device 46b is capable of connecting the third electrical power supply circuit 12c and the fourth electrical power supply circuit 12d. The connection device 46b is switched, by a non-illustrated contactor, between a state in which the third electrical power supply circuit 12c and the fourth electrical power supply circuit 12d are connected, and a state in which the third electrical power supply circuit 12c and the fourth electrical power supply circuit 12d are disconnected.

The connection device 46a and the connection device 46b may each include a relay instead of the contactor. The connection device 46a and the connection device 46b may each include a breaker instead of the contactor. The connection device 46a and the connection device 46b may each include a semiconductor switch instead of the contactor.

Normally, the first electrical power supply circuit 12a and the second electrical power supply circuit 12b are disconnected. In accordance with this feature, in the case that an abnormality has occurred in one of the first electrical power supply circuit 12a or the second electrical power supply circuit 12b, it is possible to prevent the abnormality from adversely influencing the other one. For example, in the case that an excessive electrical current has been generated in one of the first electrical power supply circuit 12a or the second electrical power supply circuit 12b, the excessive electrical current is prevented from flowing to the other one.

In the same manner, normally, the third electrical power supply circuit 12c and the fourth electrical power supply circuit 12d are disconnected. In accordance with this feature, in the case that an abnormality has occurred in one of the third electrical power supply circuit 12c or the fourth electrical power supply circuit 12d, it is possible to prevent the abnormality from adversely influencing the other one. For example, in the case that an excessive electrical current has been generated in one of the third electrical power supply circuit 12c or the fourth electrical power supply circuit 12d, the excessive electrical current is prevented from flowing to the other one.

In the case that a problem has occurred in the supply of the electrical power from the first electrical power generating device 14a to the first electrical power supply circuit 12a, the first electrical power supply circuit 12a and the second electrical power supply circuit 12b are connected by the connection device 46a. In accordance with this feature, the electrical power is supplied from the second electrical power supply circuit 12b to the first electrical power supply circuit 12a.

In the case that a problem has occurred in the supply of the electrical power from the first electrical power generating device 14a to the third electrical power supply circuit 12c, the third electrical power supply circuit 12c and the fourth electrical power supply circuit 12d are connected by the connection device 46b. In accordance with this feature, the electrical power is supplied from the fourth electrical power supply circuit 12d to the third electrical power supply circuit 12c.

In the case that a problem has occurred in the supply of the electrical power from the second electrical power generating device 14b to the second electrical power supply circuit 12b, the first electrical power supply circuit 12a and the second electrical power supply circuit 12b are connected by the connection device 46a. In accordance with this feature, the electrical power is supplied from the first electrical power supply circuit 12a to the second electrical power supply circuit 12b.

In the case that a problem has occurred in the supply of the electrical power from the second electrical power generating device 14b to the fourth electrical power supply circuit 12d, the third electrical power supply circuit 12c and the fourth electrical power supply circuit 12d are connected by the connection device 46b. In accordance with this feature, the electrical power is supplied from the third electrical power supply circuit 12c to the fourth electrical power supply circuit 12d.

The electrical power supply system 10 is provided with disconnection devices 48a to 48d. The disconnection device 48a is capable of disconnecting the first electrical power generating device 14a from the first electrical power supply circuit 12a and the connection circuit 44a. The disconnection device 48b is capable of disconnecting the second electrical power generating device 14b from the second electrical power supply circuit 12b and the connection circuit 44a. The disconnection device 48c is capable of disconnecting the first electrical power generating device 14a from the third electrical power supply circuit 12c and the connection circuit 44b. The disconnection device 48d is capable of disconnecting the second electrical power generating device 14b from the fourth electrical power supply circuit 12d and the connection circuit 44b.

The disconnection device 48a is switched, by a non-illustrated contactor, between a state in which the first electrical power generating device 14a is disconnected from the first electrical power supply circuit 12a and the connection circuit 44a, and a state in which the first electrical power generating device 14a is connected to the first electrical power supply circuit 12a and the connection circuit 44a. Similarly, the disconnection device 48b is switched, by a non-illustrated contactor, between a state in which the second electrical power generating device 14b is disconnected from the second electrical power supply circuit 12b and the connection circuit 44a, and a state in which the second electrical power generating device 14b is connected to the second electrical power supply circuit 12b and the connection circuit 44a.

Further, the disconnection device 48c is switched, by a non-illustrated contactor, between a state in which the first electrical power generating device 14a is disconnected from the third electrical power supply circuit 12c and the connection circuit 44b, and a state in which the first electrical power generating device 14a is connected to the third electrical power supply circuit 12c and the connection circuit 44b. Similarly, the disconnection device 48d is switched, by a non-illustrated contactor, between a state in which the second electrical power generating device 14b is disconnected from the fourth electrical power supply circuit 12d and the connection circuit 44b, and a state in which the second electrical power generating device 14b is connected to the fourth electrical power supply circuit 12d and the connection circuit 44b.

The disconnection devices 48a to 48d may each include a relay instead of the contactor. The disconnection devices 48a to 48d may each include a breaker instead of the contactor. The disconnection devices 48a to 48d may each include a semiconductor switch instead of the contactor.

The electrical power supply system 10 is provided with a first electrical power storage device 50a, a second electrical power storage device 50b, a third electrical power storage device 50c, and a fourth electrical power storage device 50d. The first electrical power storage device 50a is connected to the first electrical power supply circuit 12a in parallel with the first electrical power generating device 14a. The second electrical power storage device 50b is connected to the second electrical power supply circuit 12b in parallel with the second electrical power generating device 14b. The third electrical power storage device 50c is connected to the third electrical power supply circuit 12c in parallel with the first electrical power generating device 14a. The fourth electrical power storage device 50d is connected to the fourth electrical power supply circuit 12d in parallel with the second electrical power generating device 14b.

The first electrical power storage device 50a, the second electrical power storage device 50b, the third electrical power storage device 50c, and the fourth electrical power storage device 50d each include a lithium ion battery. The first electrical power storage device 50a, the second electrical power storage device 50b, the third electrical power storage device 50c, and the fourth electrical power storage device 50d may each include a secondary battery other than the lithium ion battery. The first electrical power storage device 50a, the second electrical power storage device 50b, the third electrical power storage device 50c, and the fourth electrical power storage device 50d may each include a large-capacity capacitor.

The first electrical power storage device 50a, the second electrical power storage device 50b, the third electrical power storage device 50c, and the fourth electrical power storage device 50d may each include various sensors such as a voltage sensor and an electrical current sensor, and elements such as a fuse, a relay, a breaker, a diode, a transistor, a resistor, a coil, and a capacitor.

The electrical power supply system 10 is provided with disconnection devices 52a to 52d. The disconnection device 52a is capable of disconnecting the first electrical power storage device 50a from the first electrical power supply circuit 12a and the first load device 16a. The disconnection device 52b is capable of disconnecting the second electrical power storage device 50b from the second electrical power supply circuit 12b and the second load device 16b. The disconnection device 52c is capable of disconnecting the third electrical power storage device 50c from the third electrical power supply circuit 12c and the third load device 16c. The disconnection device 52d is capable of disconnecting the fourth electrical power storage device 50d from the fourth electrical power supply circuit 12d and the fourth load device 16d.

The disconnection device 52a is switched, by a non-illustrated contactor, between a state in which the first electrical power storage device 50a is disconnected from the first electrical power supply circuit 12a and the first load device 16a, and a state in which the first electrical power storage device 50a is connected to the first electrical power supply circuit 12a and the first load device 16a. Similarly, the disconnection device 52b is switched, by a non-illustrated contactor, between a state in which the second electrical power storage device 50b is disconnected from the second electrical power supply circuit 12b and the second load device 16b, and a state in which the second electrical power storage device 50b is connected to the second electrical power supply circuit 12b and the second load device 16b.

Further, the disconnection device 52c is switched, by a non-illustrated contactor, between a state in which the third electrical power storage device 50c is disconnected from the third electrical power supply circuit 12c and the third load device 16c, and a state in which the third electrical power storage device 50c is connected to the third electrical power supply circuit 12c and the third load device 16c. Similarly, the disconnection device 52d is switched, by a non-illustrated contactor, between a state in which the fourth electrical power storage device 50d is disconnected from the fourth electrical power supply circuit 12d and the fourth load device 16d, and a state in which the fourth electrical power storage device 50d is connected to the fourth electrical power supply circuit 12d and the fourth load device 16d.

The disconnection devices 52a to 52d may each include a relay instead of the contactor. The disconnection devices 52a to 52d may each include a breaker instead of the contactor. The disconnection devices 52a to 52d may each include a semiconductor switch instead of the contactor.

The electrical power supply system 10 is provided with backflow prevention devices 54a to 54d. The backflow prevention device 54a limits the supply of the electrical power from the first electrical power storage device 50a to the first electrical power supply circuit 12a and the first electrical power generating device 14a. The backflow prevention device 54b limits the supply of the electrical power from the second electrical power storage device 50b to the second electrical power supply circuit 12b and the second electrical power generating device 14b. The backflow prevention device 54c limits the supply of the electrical power from the third electrical power storage device 50c to the third electrical power supply circuit 12c and the first electrical power generating device 14a. The backflow prevention device 54d limits the supply of the electrical power from the fourth electrical power storage device 50d to the fourth electrical power supply circuit 12d and the second electrical power generating device 14b.

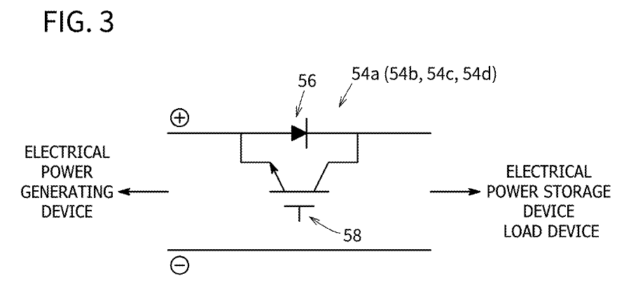

FIG. 3 is a schematic diagram illustrating an example of the backflow prevention device 54a according to the one embodiment. As shown in FIG. 3, the backflow prevention devices 54b to 54d have the same configuration as the backflow prevention device 54a. The backflow prevention device (a disconnection unit) 54a includes, for example, a diode 56 and a transistor 58.

The diode 56 is provided in a positive wire. In the case that the voltage of the anode is lower than the voltage of the cathode, almost no electrical current flows through the diode 56. In the case that the voltage of the anode has become higher than the voltage of the cathode by more than the forward voltage, an electrical current flows through the diode 56. In accordance with this feature, an electrical power is supplied via the diode 56 from the first electrical power generating device 14a to the first load device 16a and the first electrical power storage device 50a. On the other hand, no electrical power is supplied from the first load device 16a and the first electrical power storage device 50a to the first electrical power generating device 14a via the diode 56.

The transistor 58 is disposed so as to bypass the diode 56. In the case that an electrical current flows from the base to the emitter of the transistor 58, the electrical current flows from the collector to the emitter. In accordance with this feature, an electrical power is supplied from the first electrical power storage device 50a to the first electrical power generating device 14a via the first electrical power supply circuit 12a. The diode 56 may be provided in a negative wire. Further, the diode 56 may be provided in both the positive wire and the negative wire.

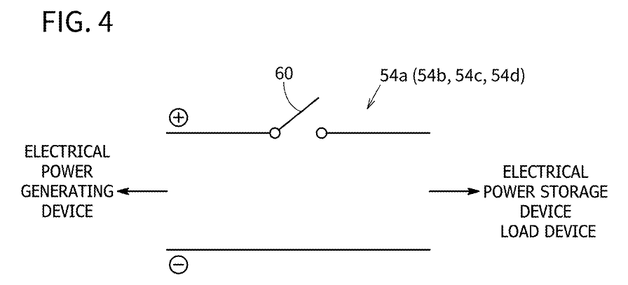

Moreover, the backflow prevention device 54a may be provided with only the diode 56, and may not be provided with the transistor 58. Further, as shown in FIG. 4, the backflow prevention device 54a may include a switching device such as a contactor 60 that switches between connection and disconnection in accordance with a switching signal from a control unit 68. The contactor 60 is disposed in at least one of the positive wire or the negative wire.

In addition to the configuration described above, the electrical power supply system 10 may include various sensors such as a voltage sensor and an electrical current sensor, and elements such as a fuse, a resistor, a coil, and a capacitor.

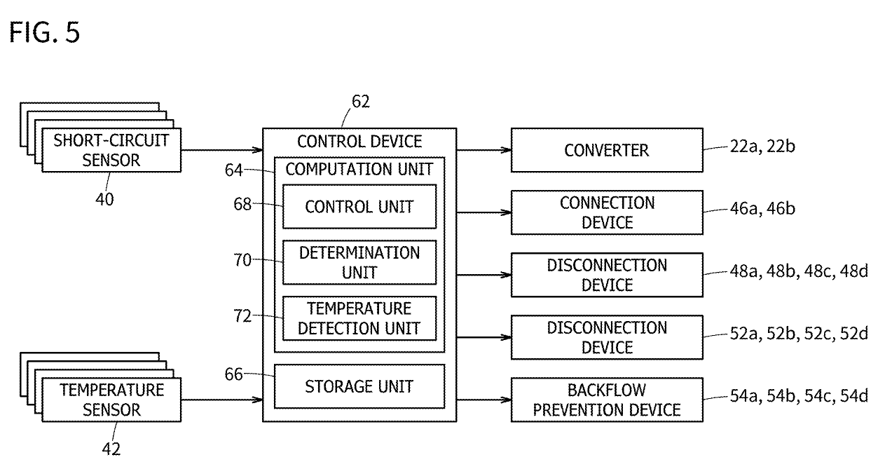

FIG. 5 is a control block diagram of a control device 62 according to the one embodiment. The electrical power supply system 10 is provided with the control device 62. The control device 62 controls the first converter 22a, the second converter 22b, the connection devices 46a and 46b, the disconnection devices 48a to 48d, the disconnection devices 52a to 52d, and the backflow prevention devices 54a to 54d.

The control device 62 includes a computation unit 64 and a storage unit 66. The computation unit 64 is a processor such as a central processing unit (CPU) or a graphics processing unit (GPU). The computation unit 64 includes the control unit 68, a determination unit 70, and a temperature detection unit 72. The control unit 68, the determination unit 70, and the temperature detection unit 72 are realized by the computation unit 64 executing a program stored in the storage unit 66. At least a portion of the control unit 68, the determination unit 70, and the temperature detection unit 72 may be realized by an integrated circuit such as an application specific integrated circuit (ASIC) or a field-programmable gate array (FPGA). At least a portion of the control unit 68, the determination unit 70, and the temperature detection unit 72 may be realized by an electronic circuit including a discrete device.

The storage unit 66 is a computer-readable non-transitory tangible storage medium. The storage unit 66 is constituted by a non-illustrated volatile memory and a non-illustrated non-volatile memory. The volatile memory, for example, is a random access memory (RAM) or the like. The non-volatile memory is, for example, a read only memory (ROM), a flash memory, or the like. Data and the like are stored in, for example, the volatile memory. A program, a table, a map, and the like are stored, for example, in the non-volatile memory. At least a portion of the storage unit 66 may be provided in the processor, the integrated circuit, or the like described above.

The control unit 68 controls the first converter 22a and the second converter 22b. Specifically, the control unit 68 controls switching of each of the plurality of switching elements 32 provided in the first converter 22a. The control unit 68 controls the second converter 22b in the same manner.

The determination unit 70 determines whether or not a short-circuit failure has occurred in any of the plurality of switching elements 32 provided in the first converter 22a, based on a signal supplied from each of the plurality of short-circuit sensors 40 provided in the first converter 22a. The determination unit 70 similarly determines whether or not a short-circuit failure has occurred in any of the plurality of switching elements 32 provided in the second converter 22b.

The temperature detection unit 72 detects the temperature of each of the plurality of switching elements 32 provided in the first converter 22a, based on a signal supplied from each of the plurality of temperature sensors 42 provided in the first converter 22a. The temperature detection unit 72 similarly detects the temperature of each of the plurality of switching elements 32 provided in the second converter 22b.

### Operations of Electrical Power Supply System 10

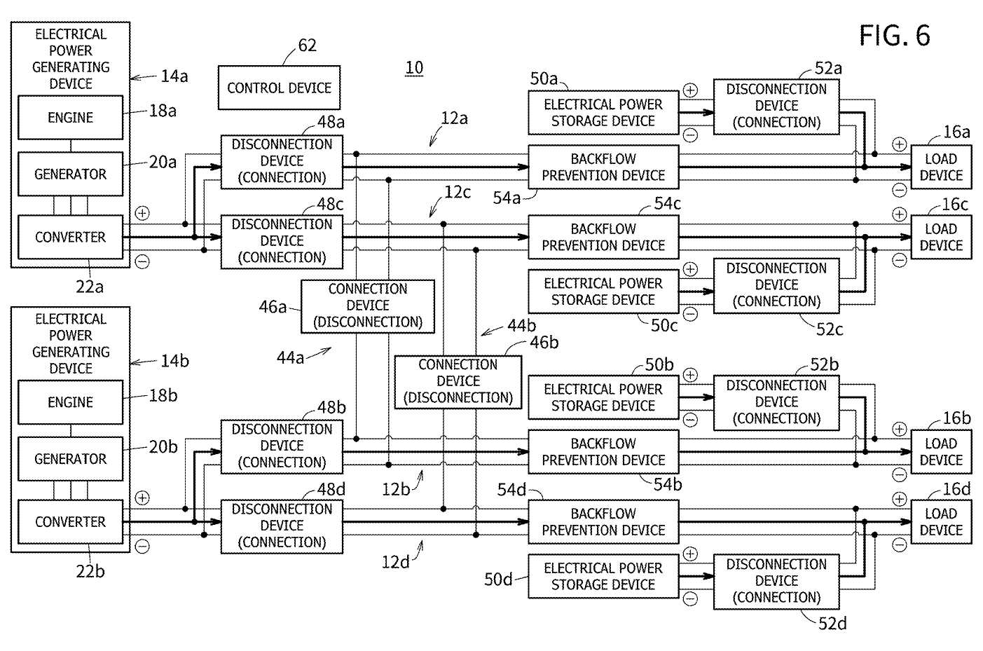

FIG. 6 is a diagram showing operations of the electrical power supply system 10 at a normal time in the one embodiment. The arrows shown in FIG. 6 indicate electrical power supply pathways.

As shown in FIG. 6, the first electrical power generating device 14a is connected to the first electrical power supply circuit 12a by the disconnection device 48a, and the first electrical power generating device 14a is connected to the third electrical power supply circuit 12c by the disconnection device 48c. In accordance with this feature, the three-phase AC electrical power that is output from the first generator 20a is converted into a DC electrical power by the first converter 22a, and the DC electrical power is supplied to the first load device 16a and the third load device 16c.

The second electrical power generating device 14b is connected to the second electrical power supply circuit 12b by the disconnection device 48b, and the second electrical power generating device 14b is connected to the fourth electrical power supply circuit 12d by the disconnection device 48d. In accordance with this feature, the three-phase AC electrical power that is output from the second generator 20b is converted into a DC electrical power by the second converter 22b, and the DC electrical power is supplied to the second load device 16b and the fourth load device 16d.

The first electrical power storage device 50a is connected to the first load device 16a by the disconnection device 52a. In accordance with this feature, the DC electrical power that is output from the first electrical power storage device 50a is supplied to the first load device 16a. The second electrical power storage device 50b is connected to the second load device 16b by the disconnection device 52b. In accordance with this feature, the DC electrical power that is output from the second electrical power storage device 50b is supplied to the second load device 16b. The third electrical power storage device 50c is connected to the third load device 16c by the disconnection device 52c. In accordance with this feature, the DC electrical power that is output from the third electrical power storage device 50c is supplied to the third load device 16c. The fourth electrical power storage device 50d is connected to the fourth load device 16d by the disconnection device 52d. In accordance with this feature, the DC electrical power that is output from the fourth electrical power storage device 50d is supplied to the fourth load device 16d.

At a normal time, the first electrical power supply circuit 12a and the second electrical power supply circuit 12b are disconnected by the connection device 46a, and the third electrical power supply circuit 12c and the fourth electrical power supply circuit 12d are disconnected by the connection device 46b.

When an abnormality occurs in the first electrical power generating device 14a or the second electrical power generating device 14b, the first electrical power supply circuit 12a and the second electrical power supply circuit 12b can be connected by the connection device 46a. Similarly, when an abnormality occurs in the first electrical power generating device 14a or the second electrical power generating device 14b, the third electrical power supply circuit 12c and the fourth electrical power supply circuit 12d can be connected by the connection device 46b. In accordance with this feature, the three-phase AC electrical power that is output from the first generator 20a is converted into a DC electrical power by the first converter 22a, and the DC electrical power can be supplied to the second load device 16b and the fourth load device 16d. Alternatively, the three-phase AC electrical power that is output from the second generator 20b is converted into a DC electrical power by the second converter 22b, and the DC electrical power can be supplied to the first load device 16a and the third load device 16c.

### Process for Coping with Short-Circuit Failure

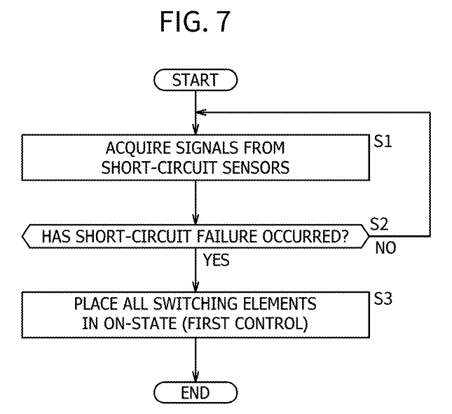

FIG. 7 is a flowchart of a process for coping with a short-circuit failure. The computation unit 64 included in the control device 62 executes the process shown in FIG. 7. Although the process executed for the first converter 22a will be described below, the process for the second converter 22b is executed in the same manner.

When a short-circuit failure occurs in any of the switching elements 32 in the first converter 22a, problems occur such as an increased amount of heat generated by the first generator 20a, and demagnetization of the first generator 20a. In order to avoid such a problem, the control unit 68 of the present embodiment executes first control described below.

In step S1, the determination unit 70 acquires signals from the short-circuit sensors 40 provided in the first converter 22a. For example, in the case that each of the short-circuit sensors 40 is a voltage sensor, the determination unit 70 acquires a signal indicating the voltage between the input and output terminals of the switching element 32. For example, in the case that each of the short-circuit sensors 40 is an electrical current sensor, the determination unit 70 acquires a signal indicating the electrical current flowing through the switching element 32.

In step S2, the determination unit 70 determines whether or not a short-circuit failure has occurred in any of the plurality of switching elements 32, based on the signals supplied from the respective short-circuit sensors 40. For example, in the case that a switching element 32 in a conduction state is detected even though an ON signal instructing the switching element 32 to be turned on is not output, the determination unit 70 determines that a short-circuit failure has occurred. In the case that a short-circuit failure has occurred in at least one of the plurality of switching elements 32 (step S2: YES), the process transitions to step S3. On the other hand, in the case that a short-circuit failure has not occurred in any of the plurality of switching elements 32 (step S2: NO), the process returns to step S1.

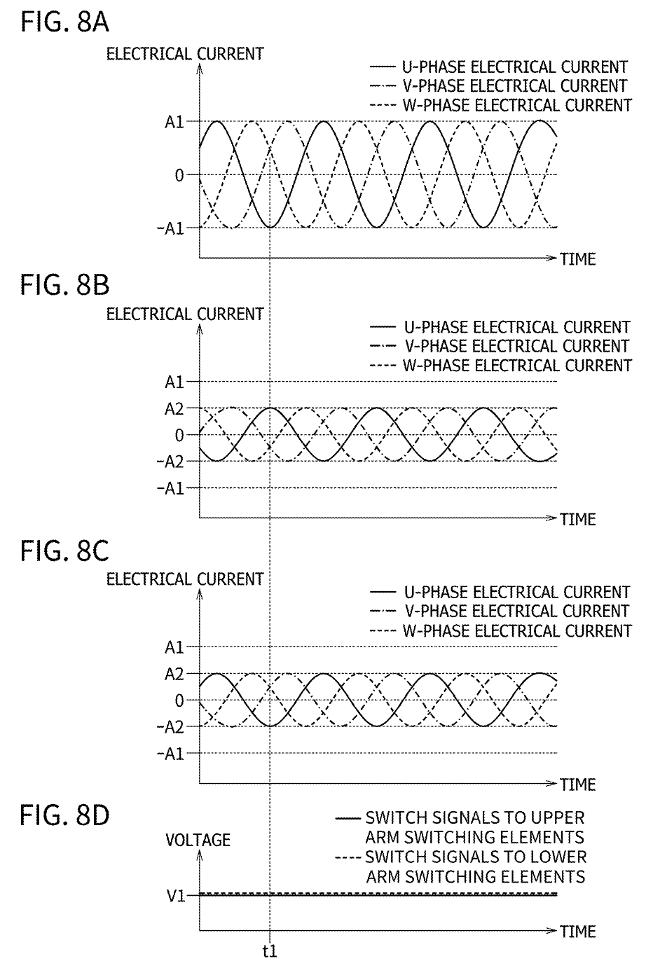

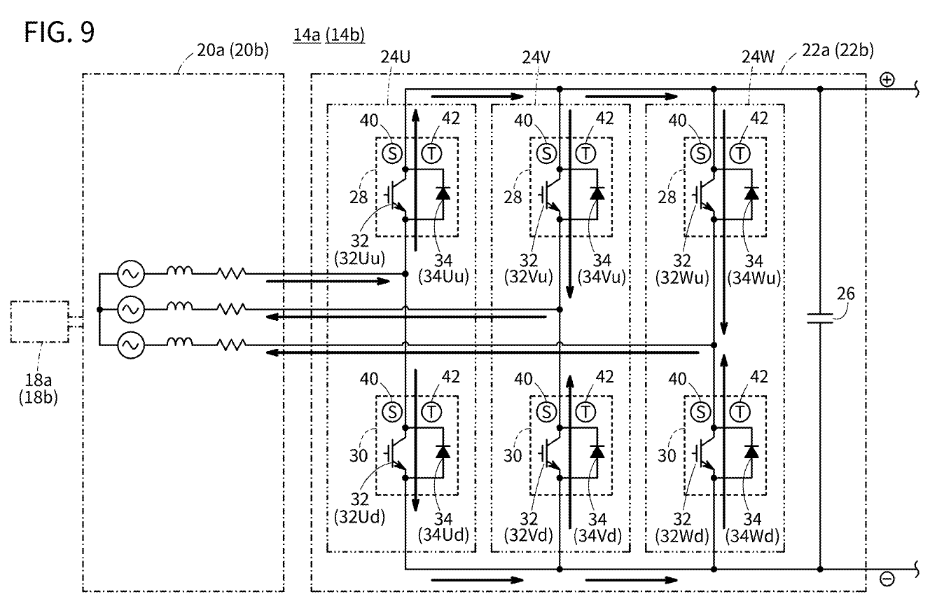

When the process transitions from step S2 to step S3, the control unit 68 places all the switching elements 32 in the ON-state. The control performed by the control unit 68 in step S3 is referred to as first control. The first control will be described with reference to FIG. 8A to FIG. 8D and FIG. 9.

FIG. 8A is a diagram showing respective phase electrical currents supplied from the first generator 20a to the first converter 22a. FIG. 8B is a diagram showing electrical currents flowing through the upper arm 28 side of the first converter 22a according to the one embodiment. FIG. 8C is a diagram showing electrical currents flowing through the lower arm 30 side of the first converter 22a according to the one embodiment. FIG. 8D is a diagram showing switch signals according to the one embodiment. FIG. 9 is a diagram showing operations of the first converter 22a according to the one embodiment. FIG. 9 shows the operations of the first converter 22a after the occurrence of a short-circuit failure. The arrows shown in FIG. 9 indicate the directions in which the electrical current flows. The directions (arrows) in which the electrical current flows and the electrical current amount change with the passage of time. FIG. 9 shows the flow of the electrical current at a point in time t1 in FIG. 8A to FIG. 8D.

When a short-circuit failure occurs, the control unit 68 continuously outputs, to all the switching elements 32, an ON signal (voltage V1) instructing the switching elements 32 to be turned on, as shown in FIG. 8D. In this state, the potential difference between the positive electrode side and the negative electrode side of the smoothing capacitor 26 provided in the first converter 22a is substantially zero. Therefore, the first electrical power generating device 14a does not supply the electrical power to the first electrical power supply circuit 12a and the third electrical power supply circuit 12c. Moreover, although the first electrical power generating device 14a is connected via the first electrical power supply circuit 12a to the first electrical power storage device 50a, since the first electrical power supply circuit 12a is provided with the backflow prevention device 54a, the supply of the electrical power (electrical current) from the first electrical power storage device 50a to the first electrical power generating device 14a is prevented. Similarly, although the first electrical power generating device 14a is connected via the third electrical power supply circuit 12c to the third electrical power storage device 50c, since the third electrical power supply circuit 12c is provided with the backflow prevention device 54c, the supply of the electrical power (electrical current) from the third electrical power storage device 50c to the first electrical power generating device 14a is prevented.

When all the switching elements 32 are placed in the ON-state, the phase electrical currents corresponding thereto continuously flow through all the switching elements 32 as shown in FIG. 9. Each of the phase electrical currents supplied from the first generator 20a to the first converter 22a flows separately through the upper arm 28 and the lower arm 30 in each of the switching element units 24U, 24V, and 24W. As shown in FIG. 8B, in each of the switching element units 24U, 24V, and 24W, the phase electrical current flowing through the switching element 32 of the upper arm 28 is reduced to about half of the phase electrical current supplied from the first generator 20a to the first converter 22a. Similarly, as shown in FIG. 8C, in each of the switching element units 24U, 24V, and 24W, the phase electrical current flowing through the switching element 32 of the lower arm 30 is reduced to about half of the phase electrical current supplied from the first generator 20a to the first converter 22a.

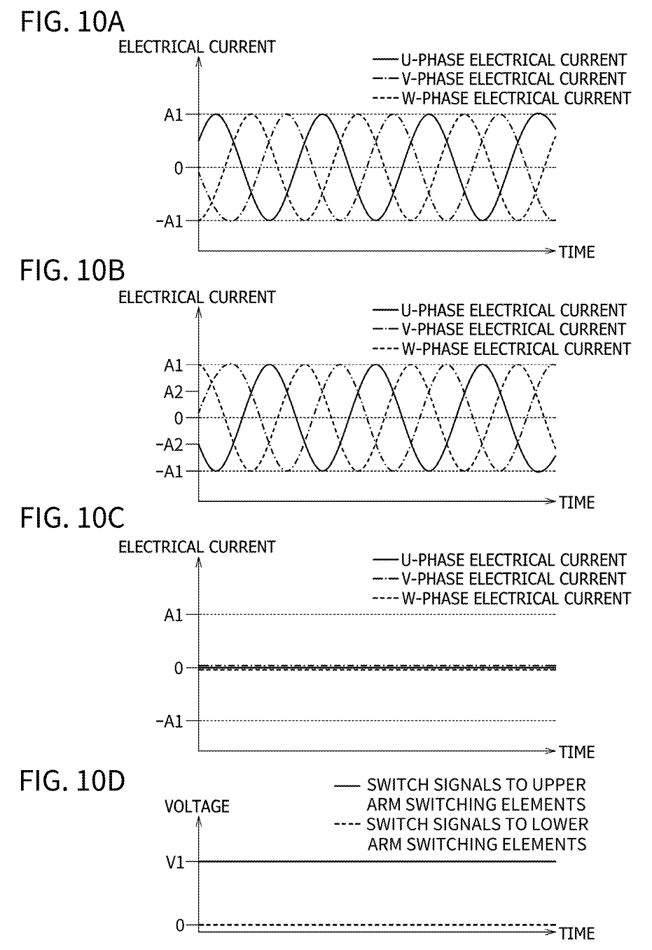

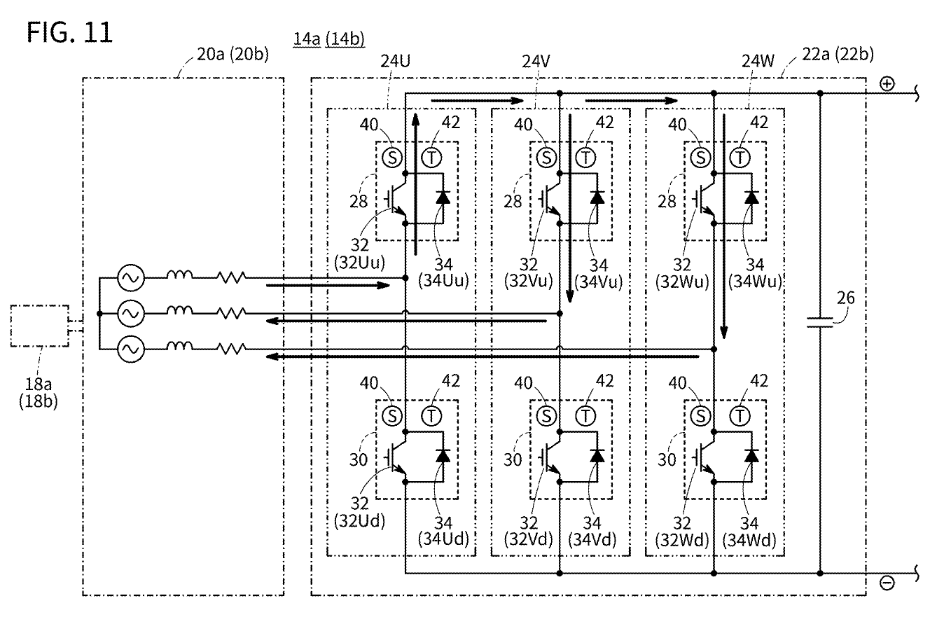

Here, a comparative example will be described with reference to FIG. 10A to FIG. 10D and FIG. 11. Similarly to the present embodiment, the comparative example is a technique for avoiding problems such as an increased amount of heat generated by the first generator 20a and demagnetization of the first generator 20a caused by a short-circuit failure of any of the switching elements 32.

FIG. 10A is a diagram showing respective phase electrical currents supplied from the first generator 20a to the first converter 22a according to the comparative example. FIG. 10B is a diagram showing electrical currents flowing through the upper arm 28 side of the first converter 22a according to the comparative example. FIG. 10C is a diagram showing electrical currents flowing through the lower arm 30 side of the first converter 22a according to the comparative example. FIG. 10D is a diagram showing switch signals according to the comparative example. FIG. 11 is a diagram showing operations of the first converter 22a according to the comparative example. FIG. 11 shows the operations of the first converter 22a after the occurrence of a short-circuit failure. The arrows shown in FIG. 11 indicate the directions in which the electrical current flows.

In the comparative example, a case is assumed in which a short-circuit failure has occurred in the switching element 32 of any of the upper arms 28. In the comparative example, the switching elements 32 of all the upper arms 28 are placed in the ON-state, and the switching elements 32 of all the lower arms 30 are placed in an OFF-state.

When the switching elements 32 of all the upper arms 28 are placed in the ON-state, the phase electrical currents corresponding thereto continuously flow through the switching elements 32 of all the upper arms 28 as shown in FIG. 11. On the other hand, when the switching elements 32 of all the lower arms 30 are placed in the OFF-state, no phase electrical current flows through the switching elements 32 of all the lower arms 30 as shown in FIG. 11. In each of the switching element units 24U, 24V, and 24W, the phase electrical current supplied from the first generator 20a to the first converter 22a concentrates on the upper arm 28. As shown in FIG. 10A and FIG. 10B, the phase electrical current flowing through the switching element 32 of each of the upper arms 28 is equal to the phase electrical current supplied from the first generator 20a to the first converter 22a.

As can be seen from FIG. 8B and FIG. 10B, according to the present embodiment, in the case that a short-circuit failure occurs in the switching element 32 of any of the upper arms 28, an increase in the amount of heat generated by the switching elements 32 of the upper arms 28 can be suppressed as compared to the comparative example. The same applies to the switching elements 32 of the lower arms 30. That is, according to the present embodiment, in the case that a short-circuit failure occurs in the switching element 32 of any of the lower arms 30, an increase in the amount of heat generated by the switching elements 32 of the lower arms 30 can be suppressed as compared to the comparative example. As described above, according to the present embodiment, it is possible to suppress the temperature rise of the switching elements 32.

### Process for Suppressing Temperature Difference

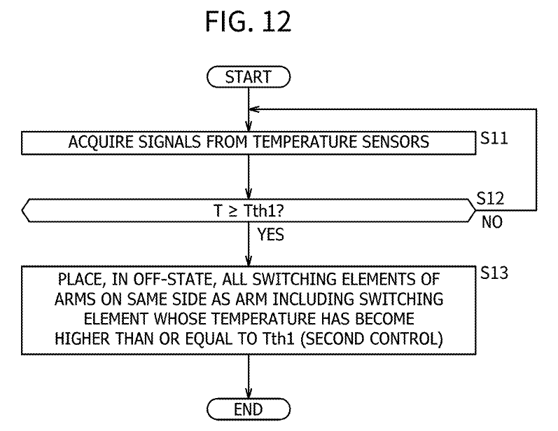

FIG. 12 is a flowchart of a process for suppressing a temperature difference among the plurality of switching elements 32. The plurality of switching elements 32 may have different rates of increase in temperature due to individual differences. The computation unit 64 included in the control device 62 suppresses the temperature difference among the plurality of switching elements 32 by executing the process shown in FIG. 12 after the start of execution of the first control (step S3) shown in FIG. 7. Although the process executed for the first converter 22a will be described below, the process for the second converter 22b is executed in the same manner.

In step S11, the temperature detection unit 72 acquires signals from the temperature sensors 42 provided in the first converter 22a.

In step S12, the temperature detection unit 72 compares a temperature T of each of the plurality of switching elements 32 with a predetermined first temperature threshold value Tth1. The first temperature threshold value Tth1 is an upper limit value of an allowable temperature of each of the switching elements 32. The first temperature threshold value Tth1 is stored in advance in the storage unit 66. In the case that the temperature T of at least one of the switching elements 32 is higher than or equal to the first temperature threshold value Tth1 (step S12: YES), the process transitions to step S13. On the other hand, in the case that the temperatures T of all the switching elements 32 are lower than the first temperature threshold value Tth1 (step S12: NO), the process returns to step S11.

When the process transitions from step S12 to step S13, the control unit 68 places, in the OFF-state, all the switching elements 32 of the arms on the same side as the arm including the switching element 32 whose temperature has reached the first temperature threshold value Tth1. The control performed by the control unit 68 in step S13 is referred to as second control.

For example, in the case that the temperature detection unit 72 detects that the temperature of any of the switching elements 32 of the plurality of upper arms 28 has become higher than or equal to the first temperature threshold value Tth1, the control unit 68 places the switching elements 32 of all the upper arms 28 in the OFF-state while keeping the switching elements 32 of all the lower arms 30 in the ON-state. Then, the temperature of each of the switching elements 32 placed in the OFF-state decreases, while the temperature of each of the switching elements 32 kept in the ON-state increases. In accordance with this feature, the temperature difference between the switching elements 32 on the upper arm 28 side and the switching elements 32 on the lower arm 30 side is suppressed.

Similarly, in the case that the temperature detection unit 72 detects that the temperature of any of the switching elements 32 of the plurality of lower arms 30 has become higher than or equal to the first temperature threshold value Tth1, the control unit 68 places the switching elements 32 of all the lower arms 30 in the OFF-state while keeping the switching elements 32 of all the upper arms 28 in the ON-state. Then, the temperature of each of the switching elements 32 placed in the OFF-state decreases, while the temperature of each of the switching elements 32 kept in the ON-state increases. In accordance with this feature, the temperature difference between the switching elements 32 on the upper arm 28 side and the switching elements 32 on the lower arm 30 side is suppressed.

Moreover, the average temperature of the switching elements 32 of the plurality of upper arms 28 and the average temperature of the switching elements 32 of the plurality of lower arms 30 may be the temperature T in step S12. In this case, in the case that the temperature detection unit 72 detects that the average temperature of the switching elements 32 of all the upper arms 28 has become higher than or equal to the first temperature threshold value Tth1, the control unit 68 places the switching elements 32 of all the upper arms 28 in the OFF-state. Further, in the case that the temperature detection unit 72 detects that the average temperature of the switching elements 32 of all the lower arms 30 has become higher than or equal to the first temperature threshold value Tth1, the control unit 68 places the switching elements 32 of all the lower arms 30 in the OFF-state. In accordance with this feature, the temperature difference between the switching elements 32 on the upper arm 28 side and the switching elements 32 on the lower arm 30 side is suppressed.

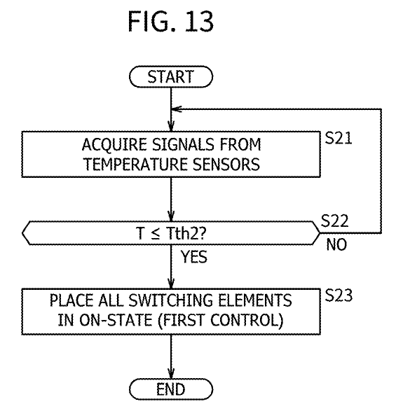

FIG. 13 is a flowchart of a process for shifting from the second control to the first control. The computation unit 64 included in the control device 62 executes the process shown in FIG. 13 after executing the second control (step S13) shown in FIG. 12. Although the process executed for the first converter 22a will be described below, the process for the second converter 22b is executed in the same manner.

In step S21, the temperature detection unit 72 acquires signals from the temperature sensors 42 provided in the first converter 22a.

In step S22, the temperature detection unit 72 compares the temperature T of each of the plurality of switching elements 32, which have been placed in the OFF-state in step S13 of FIG. 12, with a predetermined second temperature threshold value Tth2. The second temperature threshold value Tth2 is any temperature lower than the first temperature threshold value Tth1. The second temperature threshold value Tth2 is stored in advance in the storage unit 66. In the case that the temperature T of each of the plurality of switching elements 32 in the OFF-state is lower than or equal to the second temperature threshold value Tth2 (step S22: YES), the process transitions to step S23. On the other hand, in the case that the temperature T of any of the plurality of switching elements 32 in the OFF-state is higher than the second temperature threshold value Tth2 (step S22: NO), the process returns to step S21.

When the process transitions from step S22 to step S23, the control unit 68 places all the switching elements 32 in the ON-state. That is, the control unit 68 executes the first control. Thereafter, the computation unit 64 (the temperature detection unit 72 and the control unit 68) executes either the process shown in FIG. 12 or the process shown in FIG. 13.

Moreover, the average temperature of the switching elements 32 of the plurality of upper arms 28 and the average temperature of the switching elements 32 of the plurality of lower arms 30 may be the temperature T in step S22.

### Moving Object 80 Including Electrical Power Supply System 10

FIG. 14 is a schematic diagram of a moving object 80. As shown in FIG. 14, the electrical power supply system 10 is mounted on the moving object 80.

The moving object 80 of the present embodiment is an electric vertical take-off and landing aircraft (eVTOL aircraft). The moving object 80 is provided with eight VTOL rotors 82. The VTOL rotors 82 generate upward thrust for a fuselage 84. The moving object 80 is provided with eight electric motors 86. One of the electric motors 86 drives one of the VTOL rotors 82. The moving object 80 includes two cruise rotors 88. The cruise rotors 88 generate forward thrust for the fuselage 84. The moving object 80 is provided with four electric motors 90. Two of the electric motors 90 drive one of the cruise rotors 88.

Each of the first load device 16a, the second load device 16b, the third load device 16c, and the fourth load device 16d includes two electric motors 86 and one electric motor 90. Each of the first load device 16a, the second load device 16b, the third load device 16c, and the fourth load device 16d may include a low-voltage drive device in addition to the electric motors 86 and the electric motor 90.

The moving object 80 is not limited to being an aircraft, but may be a ship, an automobile, a train, or the like.

### Supplementary Note

The following supplementary notes are further disclosed in relation to the above-described embodiment.

### Supplementary Note 1

The electrical power supply system (10) of the present disclosure includes: the converter (22a, 22b) including the plurality of switching elements (32) and configured to convert a multiphase AC voltage output from the generator (20a, 20b) into a DC voltage; the control unit (68) configured to control the converter; and the determination unit (70) configured to determine whether or not a short-circuit failure has occurred in any of the plurality of switching elements provided in the converter, wherein the converter includes the plurality of switching element units (24u, 24v, 24W) corresponding to respective phases of the multiphase AC voltage, each of the switching element units including the upper arm-side switching element that is one of the switching elements on the upper arm (28) side and the lower arm-side switching element that is one of the switching elements on the lower arm (30) side, the upper arm-side switching element and the lower arm-side switching element being connected in series to each other, and in the case that the determination unit determines that the short-circuit failure has occurred in any of the plurality of switching elements provided in the converter, the control unit can perform first control of placing, in an ON-state, all of the switching elements provided in the converter.

According to the above configuration, in the case that a short-circuit failure occurs in any of the switching elements, it is possible not only to avoid problems such as an increased amount of heat generated by the generator and demagnetization of the generator, but also to suppress an increase in the amount of heat generated by the switching elements. Therefore, according to the above configuration, it is possible to suppress the temperature rise of the switching elements.

### Supplementary Note 2

The electrical power supply system according to Supplementary Note 1 may further include the temperature detection unit (72) configured to detect the temperature of each of the switching elements, wherein the control unit may execute, after executing the first control, second control of controlling the converter based on the temperature detected by the temperature detection unit, and in the second control, in the case that the temperature detection unit detects that the temperature (T) of at least one of a plurality of the upper arm-side switching elements becomes higher than or equal to the predetermined temperature threshold value (Tth1), all of the upper arm-side switching elements may be turned off in a state in which all of a plurality of the lower arm-side switching elements are placed in the ON-state, and in the second control, in the case that the temperature detection unit detects that the temperature of at least one of the plurality of lower arm-side switching elements becomes higher than or equal to the temperature threshold value, all of the lower arm-side switching elements may be turned off in a state in which all of the plurality of upper arm-side switching elements are placed in the ON-state.

According to the above configuration, the temperature difference between the upper arm-side switching elements and the lower arm-side switching elements is suppressed.

### Supplementary Note 3

The electrical power supply system according to Supplementary Note 1 may further include the electrical power storage device (50a, 50b, 50c, 50d) configured to be charged with the DC voltage supplied from the converter, and the disconnection unit (54a, 54b, 54c, 54d) disposed between the electrical power storage device and the converter and configured to cut off the supply of the electrical power from the electrical power storage device to the converter.

According to the above configuration, it is possible to prevent the supply (backflow) of the electrical power (electrical current) from the electrical power storage device to the electrical power generating device.

### Supplementary Note 4

In the electrical power supply system according to Supplementary Note 3, the disconnection unit may be the switching device (60) configured to switch between connection and disconnection in accordance with the switching signal from the control unit.

### Supplementary Note 5

In the electrical power supply system according to Supplementary Note 3, the disconnection unit may be the diode (56) configured to allow the electrical current to flow from the converter to the electrical power storage device and prevent the electrical current from flowing from the electrical power storage device to the converter.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of the operations and the order of the processes are illustrated as examples, and the present disclosure is not necessarily limited to these features. The same also applies to cases in which numerical values or mathematical expressions are used in the description of the above-described embodiments.

1. An electrical power supply system comprising:
a converter including a plurality of switching elements and configured to convert a multiphase alternating current voltage output from a generator into a direct current voltage; and
one or more processors that execute computer-executable instructions stored in a memory,
wherein the converter includes a plurality of switching element units corresponding to respective phases of the multiphase alternating current voltage, each of the switching element units including an upper arm-side switching element that is one of the switching elements on an upper arm side, and a lower arm-side switching element that is one of the switching elements on a lower arm side, the upper arm-side switching element and the lower arm-side switching element being connected in series to each other, and
the one or more processors execute the computer-executable instructions to cause the electrical power supply system to, in a case that it is determined that a short-circuit failure has occurred in any of the plurality of switching elements provided in the converter, perform first control of placing, in an ON-state, all of the switching elements provided in the converter.

2. The electrical power supply system according to claim 1, wherein
the one or more processors cause the electrical power supply system to execute, after executing the first control, second control of controlling the converter based on a temperature of each of the switching elements, and wherein
in the second control, in a case that it is detected that the temperature of at least one of a plurality of the upper arm-side switching elements becomes higher than or equal to a predetermined temperature threshold value, all of the upper arm-side switching elements are turned off in a state in which all of a plurality of the lower arm-side switching elements are placed in the ON-state, and
in the second control, in a case that it is detected that the temperature of at least one of the plurality of lower arm-side switching elements becomes higher than or equal to the predetermined temperature threshold value, all of the lower arm-side switching elements are turned off in a state in which all of the plurality of upper arm-side switching elements are placed in the ON-state.

3. The electrical power supply system according to claim 1, further comprising:
an electrical power storage device configured to be charged with the direct current voltage supplied from the converter; and
a disconnection unit disposed between the electrical power storage device and the converter, and configured to cut off supply of an electrical power from the electrical power storage device to the converter.

4. The electrical power supply system according to claim 3, wherein
the disconnection unit is a switching device.

5. The electrical power supply system according to claim 3, wherein
the disconnection unit is a diode configured to allow an electrical current to flow from the converter to the electrical power storage device and prevent the electrical current from flowing from the electrical power storage device to the converter.
